(19) United States
(12) Patent Application Publication
(10) Pub. No.: US 2023/0281275 A1
(43) Pub. Date: Sep. 7, 2023

(54) IDENTIFICATION METHOD AND INFORMATION PROCESSING DEVICE

(71) Applicant: Fujitsu Limited, Kawasaki-shi (JP)

(72) Inventor: Akira URA, Yokohama (JP)

(73) Assignee: Fujitsu Limited, Kawasaki-shi (JP)

(21) Appl. No.: 18/092,948

(22) Filed: Jan. 4, 2023

(30) Foreign Application Priority Data
Mar. 4, 2022 (JP) 2022-033339

(51) Int. Cl. G06F 18/10; G06N 20/00

(52) U.S. Cl. CPC G06F 18/10; G06N 20/00

(57) ABSTRACT

A non-transitory computer-readable recording medium stores a program for causing a computer to execute a process, the process includes obtaining first change information, which indicates a change in a feature of a first dataset when first preprocessing is performed on the first dataset, inputting the first change information to a trained machine learning model that outputs an inference result regarding preprocessing information that identifies each piece of second preprocessing for a second dataset, the trained machine learning model being trained by using training data in which the preprocessing information is associated with second change information that indicates a change in a feature of the second dataset when each piece of second preprocessing is performed, and identifying one or more pieces of recommended preprocessing that correspond to the first preprocessing based on the inference result that is output in response to the input of the first change information.

### CROSS-REFERENCE TO RELATED APPLICATION

This application is based upon and claims the benefit of priority of the prior Japanese Patent Application No. 2022-033339, filed on Mar. 4, 2022, the entire contents of which are incorporated herein by reference.

### FIELD

The embodiments discussed herein are related to an identification method and an information processing device.

### BACKGROUND

Automation techniques for automating data analysis using machine learning, such as automated machine learning (AutoML), for example, have been used. According to such automation techniques, a search method is used to search for what kind of preprocessing is to be preferably executed as preprocessing for machine learning. At this time, in order to narrow a search space, a search method, such as classifying preprocessing according to each function and selecting one or a plurality of preprocessing candidates from each of the individual classifications, is also used. For example, for preprocessing classification of “filling in missing data”, the most effective preprocessing is selected from among “filling with zero”, “filling with average”, “estimating from other locations of the data”, and the like.

In recent years, there has been known a technique of automatically determining, when preprocessing is provided, other pieces of preprocessing to be searched for by using documents describing parts of preprocessing, to search for more efficient preprocessing and the like other than the provided preprocessing. For example, in a case where certain preprocessing c and a document D(c) are provided and n combinations of preprocessing and documents “(preprocessing ci, document D(ci)) to (preprocessing cn, document D(cn))” are provided, similarity levels between the document D(c) and other n documents are calculated, and a range of the similar preprocessing to be searched for is determined according to the similarity levels between the documents. Note that, for example, input, output, descriptions of parameters, and the like are described in the documents.

U.S. Patent Application Publication No. 2020/0184382 is disclosed as related art.

### SUMMARY

According to an aspect of the embodiments, a non-transitory computer-readable recording medium stores a program for causing a computer to execute a process, the process includes obtaining first change information, which indicates a change in a feature of a first dataset when first preprocessing is performed on the first dataset, inputting the first change information to a trained machine learning model that outputs an inference result regarding preprocessing information in response to an input of the first change information, the preprocessing information identifying each of a plurality of pieces of second preprocessing for a second dataset, the trained machine learning model being trained by machine learning using training data in which the preprocessing information as an objective variable is associated with second change information as an explanatory variable, the second change information indicating a change in a feature of the second dataset when each of the plurality of pieces of second preprocessing is performed, and identifying, among the plurality of pieces of second preprocessing, one or more pieces of recommended preprocessing that correspond to the first preprocessing based on the inference result that is output in response to the input of the first change information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an information processing device according to a first embodiment;

FIG. 2 is a diagram illustrating a meta-feature;

FIG. 3 is a diagram illustrating a functional configuration of the information processing device according to the first embodiment;

FIG. 4 is a diagram illustrating generation of meta-features and training data;

FIG. 5 is a diagram illustrating machine learning;

FIG. 6 is a diagram illustrating identification of similar preprocessing;

FIG. 7 is a flowchart illustrating a flow of a machine learning process according to the first embodiment;

FIG. 8 is a flowchart illustrating a flow of an identification process according to the first embodiment;

FIG. 9 is a diagram illustrating identification of similar preprocessing according to a second embodiment;

FIG. 10 is a diagram illustrating identification of similar preprocessing according to a third embodiment; and

FIG. 11 is a diagram illustrating an exemplary hardware configuration.

### DESCRIPTION OF EMBODIMENTS

However, the technique described above is a technique using the preprocessing documents, which may not be applied unless a document corresponding to preprocessing exists and does not directly reflect preprocessing contents, whereby it is difficult to say that accuracy in identifying similar preprocessing is high.

Hereinafter, embodiments of an identification method and an information processing device disclosed in the present application will be described in detail with reference to the drawings. Note that the embodiments do not limit the present disclosure. Furthermore, the individual embodiments may be appropriately combined with each other as long as there is no contradiction.

### First Embodiment

<Description of Information Processing Device>

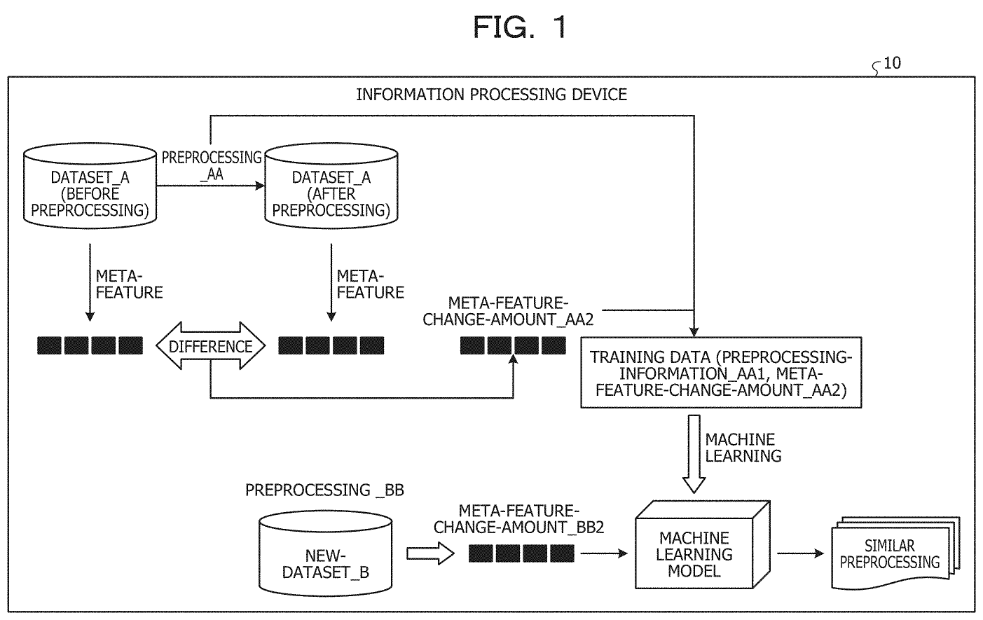

FIG. 1 is a diagram illustrating an information processing device 10 according to a first embodiment. The information processing device 10 illustrated in FIG. 1 is an exemplary computer device capable of selecting similar preprocessing by, when a dataset and preprocessing are provided, focusing on a change of the dataset caused by the preprocessing. For example, when the dataset and the preprocessing are provided, the information processing device 10 automatically selects, using AutoML or the like, other pieces of preprocessing to be searched for, to search for more efficient preprocessing and the like other than the provided preprocessing.

Note that the preprocessing is processing to be performed before execution of machine learning, such as categorical data processing, missing value processing, feature conversion or addition, dimension deletion, or the like, and there are many kinds of preprocessing according to processing combinations and detailed contents. Furthermore, the similar preprocessing is exemplary recommended preprocessing, and includes preprocessing similar to the provided preprocessing, preprocessing alternative to the provided preprocessing, additional preprocessing to be added as a selection target, and the like.

Such an information processing device 10 obtains a change in the feature of a dataset when specific preprocessing is performed on the dataset. Then, the information processing device 10 inputs the obtained feature change to a trained machine learning model that is trained by machine learning using training data in which preprocessing information for identifying preprocessing for a dataset is associated with a feature change of the dataset when the preprocessing is performed and that uses a feature change as an input and outputs corresponding preprocessing information. Thereafter, the information processing device 10 identifies similar preprocessing corresponding to the specific preprocessing on the basis of the output result in response to the input.

For example, in a case where a dataset (dataset_A) and preprocessing (preprocessing_AA) are provided as illustrated in FIG. 1, the information processing device 10 performs the preprocessing_AA on the dataset_A. Then, the information processing device 10 obtains a meta-feature of the dataset_A before the execution of the preprocessing_AA and a meta-feature of the dataset_A after the execution of the preprocessing_AA, and calculates a difference between them as a meta-feature-change-amount_AA2.

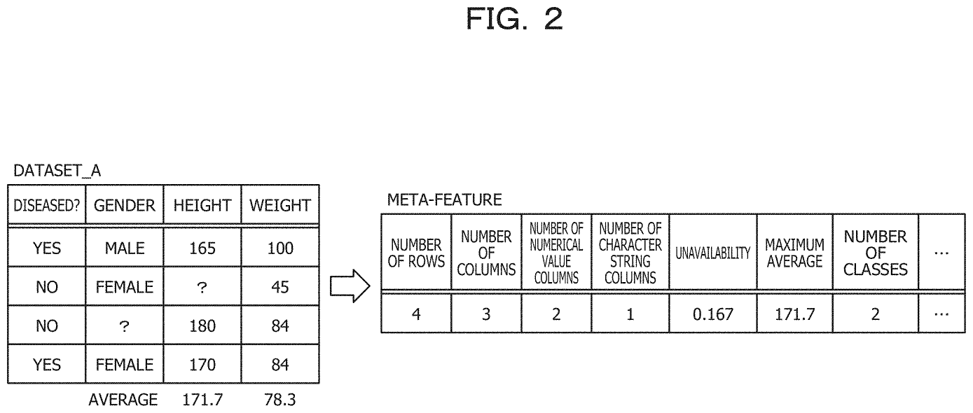

Here, the meta-feature will be described. FIG. 2 is a diagram illustrating the meta-feature. As illustrated in FIG. 2, the dataset_A is a dataset having individual columns (items) of “diseased?”, “gender”, “height”, and “weight”. Here, “diseased?” corresponds to an objective variable, and “gender, height, and weight” correspond to explanatory variables. Note that an objective variable having two classes of “YES” and “NO” is exemplified here as an example.

The meta-feature is generated using at least one of data including the number of rows of the dataset_A and the number of columns of the dataset_A excluding the objective variable, the number of columns of numerical data included in the dataset_A, the number of columns of character strings included in the dataset_A, a percentage of data missing values included in the dataset_A, a statistic (mean or variance) of each column included in the dataset_A, or the number of classes of the objective variable included in the dataset_A. For example, in the case of dataset_A illustrated in FIG. 2, the number of rows is four, the number of columns of the explanatory variables are three columns of “gender”, “height”, and “weight”, the number of columns of numerical values among the explanatory variables is two columns of “height” and “weight”, and the number of columns of character strings among explanatory variables is one column of “gender”. Furthermore, since two of the total 12 values are missing, the percentage of data missing values is “2/12≈0.167”. Furthermore, the maximum average is “171.7” out of the average value of the height “171.7” and the average value of the weight “78.3”, and the number of classes is “2” including two values of “YES” in positive response to the explanatory variable “diseased” and “NO” in negative response.

As a result, in the example of FIG. 2, the meta-feature of “4, 3, 2, 1, 0.167, 171.7, 2” may be adopted as the “number of rows, number of columns, number of columns of numerical values, number of columns of character strings, unavailability, maximum average, number of classes”.

Returning to FIG. 1, the information processing device 10 generates training data including preprocessing information (preprocessing-information_AA1) for identifying contents and the like of the preprocessing_AA and a meta-feature change amount (meta-feature-change-amount_AA2). Then, the information processing device 10 inputs the training data to the machine learning model, and executes the machine learning using the meta-feature-change-amount_AA2 as the explanatory variable (feature) and the preprocessing-information_AA1 as the objective variable, thereby generating a trained machine learning model. In this manner, the information processing device 10 is enabled to generate a machine learning model that outputs, in response to an input of a meta-feature, a classification result (inference result) in which individual pieces of preprocessing information are associated with probabilities of the individual pieces of preprocessing information.

Thereafter, when a new dataset (new-dataset_B) and preprocessing (preprocessing_BB) are specified, the information processing device 10 performs preprocessing_BB on new-dataset_B, and calculates a change amount of the meta-feature (meta-feature-change-amount_BB2) with the items similar to those of dataset_A. Then, the information processing device 10 inputs the calculated meta-feature-change-amount_BB2 to the machine learning model, and obtains an inference result. Note that a result of a similar preprocessing list included in the inference result includes, for example, information for identifying similar preprocessing and a probability (prediction probability) indicating a percentage, index, or the like that the similar preprocessing is relevant to the preprocessing corresponding to the input meta-feature.

In this manner, the information processing device 10 is enabled to select appropriate similar preprocessing without using a preprocessing document, and to select appropriate similar preprocessing by directly considering the function of the preprocessing. As a result, the information processing device 10 is enabled to accurately identify preprocessing similar to the provided preprocessing.

<Functional Configuration of Information Processing Device>

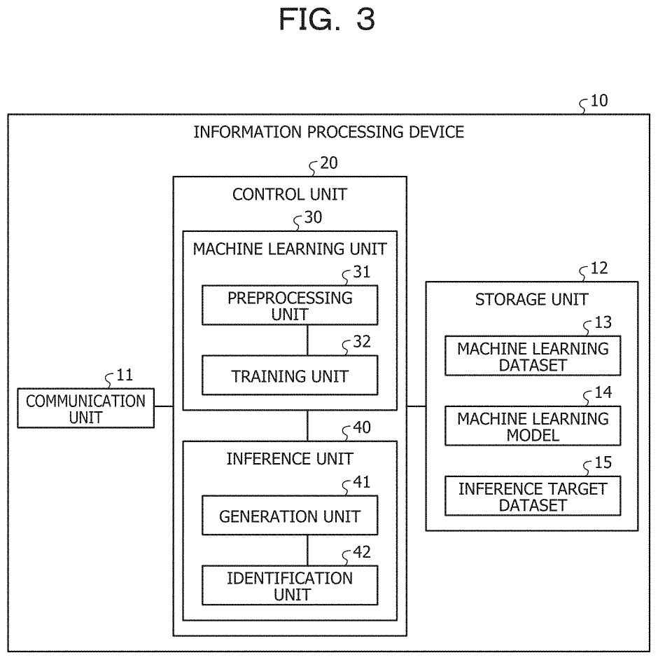

FIG. 3 is a diagram illustrating a functional configuration of the information processing device 10 according to the first embodiment. As illustrated in FIG. 3, the information processing device 10 includes a communication unit 11, a storage unit 12, and a control unit 20.

The communication unit 11 is a processing unit that controls communication with another device and is implemented by, for example, a communication interface or the like. For example, the communication unit 11 receives various kinds of information from an administrator terminal used by an administrator, and transmits a processing result of the control unit 20 and the like to the administrator terminal.

The storage unit 12 is an exemplary processing unit that stores various types of data, programs to be executed by the control unit 20, and the like, and is implemented by, for example, a memory, a hard disk, or the like. The storage unit 12 stores a machine learning dataset 13, a machine learning model 14, and an inference target dataset 15.

The machine learning dataset 13 is an exemplary database that stores data to be used for training of the machine learning model 14. For example, each piece of data stored in the machine learning dataset 13 is data including an objective variable and an explanatory variable, which serves as original data for generating training data to be used for the training of the machine learning model 14. Note that examples of the machine learning dataset 13 include dataset_A in FIG. 2.

The machine learning model 14 is an exemplary classifier that performs multiclass classification, and is generated by the control unit 20. The machine learning model 14 is generated using training data having “preprocessing information for identifying preprocessing” as an objective variable and “meta-feature change amount” as an explanatory variable. The generated machine learning model 14 outputs an inference result including information associated with the relevant preprocessing information according to the input data. Note that various models such as a neural network may be adopted for the machine learning model 14.

The inference target dataset 15 is an exemplary database that stores data to be searched to search for the relevant preprocessing. For example, in a case where the inference target dataset 15 and preprocessing are provided, the machine learning model 14 is used to identify, other than the provided preprocessing, preprocessing to be searched for by AutoML or the like. Note that examples of the inference target dataset 15 include new-dataset_B in FIG. 1.

The control unit 20 is a processing unit that takes overall control of the information processing device 10, and is implemented by, for example, a processor or the like. The control unit 20 includes a machine learning unit 30 and an inference unit 40. Note that the machine learning unit 30 and the inference unit 40 are implemented by a process or the like executed by a processor or an electronic circuit included in the processor.

The machine learning unit 30 is a processing unit that generates the machine learning model 14, and includes a preprocessing unit 31 and a training unit 32.

The preprocessing unit 31 is a processing unit that generates training data to be used for the training of the machine learning model 14. For example, the preprocessing unit 31 generates each piece of training data including the objective variable “preprocessing information” and the explanatory variable “meta-feature change amount”.

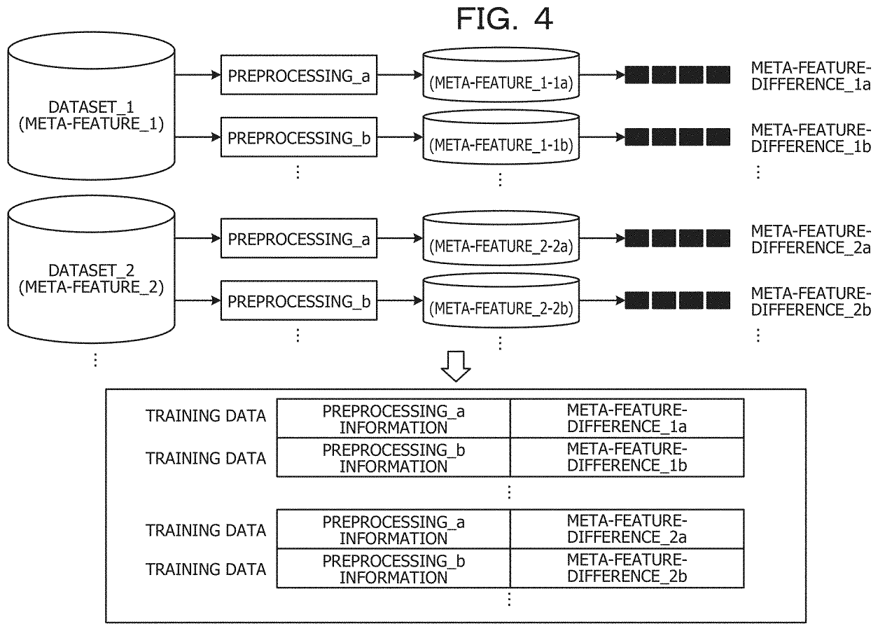

FIG. 4 is a diagram illustrating generation of meta-features and training data. Here, an exemplary case where two datasets (dataset_1 and dataset_2) and a plurality of pieces of preprocessing (preprocessing_a to preprocessing_z) are provided will be described. Note that preprocessing information for identifying preprocessing_a will be referred to as preprocessing_a information here.

As illustrated in FIG. 4, the preprocessing unit 31 generates a meta-feature (meta-feature_1) from dataset_1. Subsequently, the preprocessing unit 31 performs preprocessing_a on dataset_1, and generates a meta-feature (meta-feature_1-1a) of dataset_1 after preprocessing. Then, the preprocessing unit 31 calculates “(meta-feature_1)−(meta-feature_1-1a)” as a meta-feature difference (meta-feature-difference_1a). As a result, the preprocessing unit 31 generates training data including preprocessing_a information and meta-feature-difference_1a” as the “objective variable and explanatory variable”.

Furthermore, the preprocessing unit 31 performs preprocessing (preprocessing_b) on dataset_1, and generates a meta-feature (meta-feature_1-1b) of dataset_1 after preprocessing. Then, the preprocessing unit 31 calculates “(meta-feature_1)−(meta-feature_1-1b)” as a meta-feature difference (meta-feature-difference_1b). As a result, the preprocessing unit 31 generates training data including the “preprocessing_b information and meta-feature-difference_1b” as the “objective variable and explanatory variable”.

The preprocessing unit 31 generates a meta-feature (meta-feature_2) from a dataset (dataset 2) in a similar manner. Subsequently, the preprocessing unit 31 performs preprocessing_a on dataset_2, and generates a meta-feature (meta-feature_2-2a) of dataset_2 after preprocessing. Then, the preprocessing unit 31 calculates “(meta-feature_2)−(meta-feature_2-2a)” as a meta-feature difference (meta-feature-difference_2a). As a result, the preprocessing unit 31 generates training data including the “preprocessing_a information and meta-feature-difference_2a” as the “objective variable and explanatory variable”.

Furthermore, the preprocessing unit 31 performs preprocessing_b on dataset_2, and generates a meta-feature (meta-feature_2-2b) of dataset_2 after preprocessing. Then, the preprocessing unit 31 calculates “(meta-feature_2)−(meta-feature_2-2b)” as a meta-feature difference (meta-feature-difference_2b). As a result, the preprocessing unit 31 generates training data including the “preprocessing_b information and meta-feature-difference_2b” as the “objective variable and explanatory variable”.

In this manner, the preprocessing unit 31 calculates a meta-feature difference when each piece of the provided preprocessing is executed for each of the provided datasets. Then, the preprocessing unit 31 associates the individual pieces of preprocessing with the individual meta-feature differences, thereby generating training data. Then, the preprocessing unit 31 outputs each piece of the generated training data to the training unit 32.

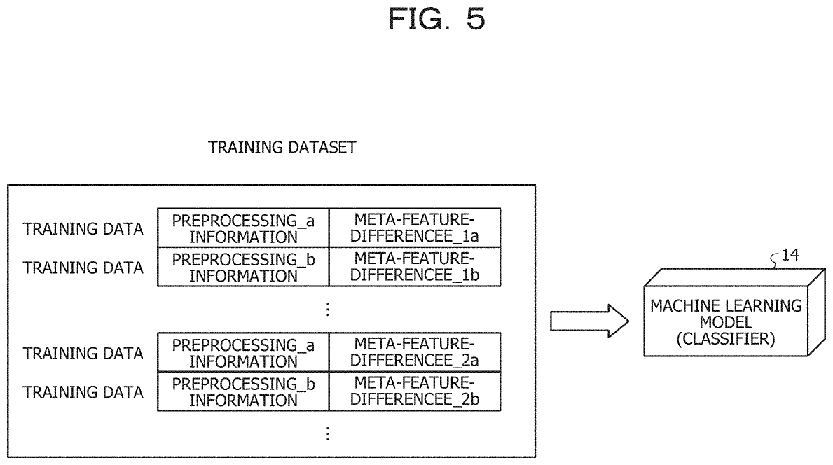

The training unit 32 is a processing unit that generates the machine learning model 14 by machine learning using a training dataset including the individual pieces of the training data generated by the preprocessing unit 31. FIG. 5 is a diagram illustrating the machine learning. As illustrated in FIG. 5, the training unit 32 inputs each piece of the training data including the “objective variable (preprocessing information)” and the “explanatory variable (meta-feature difference)” to the machine learning model 14, and executes the training of the machine learning model 14 using backpropagation or the like in such a manner that a difference between the objective variable and the output result of the machine learning model 14 becomes smaller (optimized).

The inference unit 40 is a processing unit that executes, when a dataset and preprocessing are provided, inference of similar preprocessing that is similar to the provided preprocessing using the generated machine learning model 14, and includes a generation unit 41 and an identification unit 42.

The generation unit 41 is a processing unit that generates input data to the machine learning model 14. The identification unit 42 is a processing unit that inputs the input data to the machine learning model 14 and identifies similar preprocessing on the basis of an output result (inference result) of the machine learning model 14.

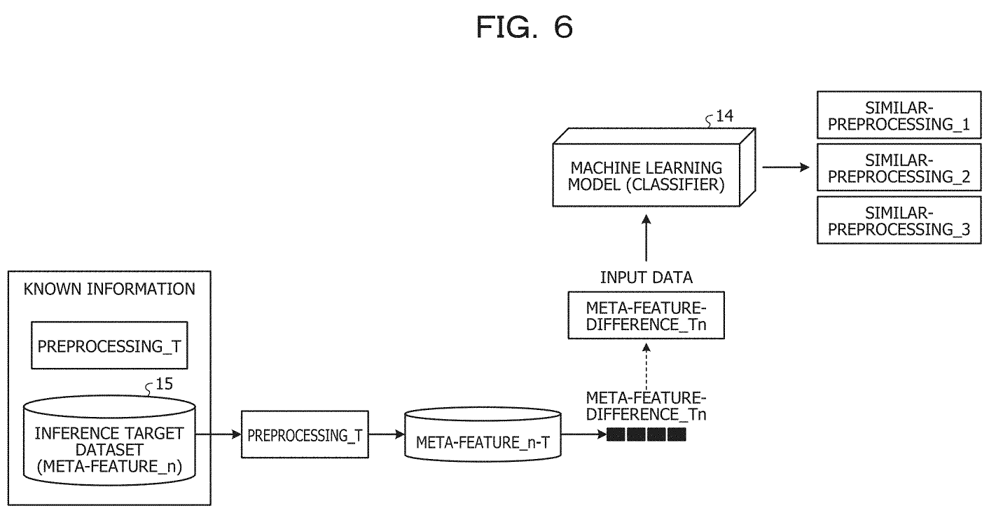

Here, a series of processes for identifying similar preprocessing will be described with reference to FIG. 6. FIG. 6 is a diagram illustrating identification of similar preprocessing. In the example of FIG. 6, an exemplary case where the “inference target dataset 15 and preprocessing (preprocessing_T)” are provided as known information will be described.

As illustrated in FIG. 6, the generation unit 41 generates a meta-feature (meta-feature_n) of the provided inference target dataset 15. Subsequently, the generation unit 41 performs preprocessing_T on the inference target dataset 15, and generates a meta-feature (meta-feature_n−T) of the inference target dataset 15 after the execution of preprocessing_T. Then, the generation unit 41 calculates “(meta-feature_n)−(meta-feature_n−T)” as a meta-feature difference (meta-feature-difference_Tn). Thereafter, the generation unit 41 outputs meta-feature-difference_Tn to the identification unit 42.

Thereafter, the identification unit 42 inputs meta-feature-difference_Tn generated by the generation unit 41 to the machine learning model 14, and obtains an output result (inference result). Here, the output result is associated with similar preprocessing and a prediction probability that the similar preprocessing is appropriate (relevant). Accordingly, the identification unit 42 identifies similar-preprocessing (similar-preprocessing_1, similar-preprocessing_2, and similar-preprocessing_3) as the top N (N is any number) pieces of similar preprocessing with a high prediction probability in the output result. Note that it is not limited to this, and the identification unit 42 may identify similar preprocessing with a prediction probability equal to or higher than a threshold value, or may identify the top N pieces of similar preprocessing with a prediction probability equal to or higher than the threshold value.

Furthermore, the identification unit 42 may output a list of the identified similar preprocessing to a display unit such as a display device, or may transmit the list to the administrator terminal. Note that the identification unit 42 may also output the inference result itself to the display unit such as a display device, or may transmit it to the administrator terminal.

<Process Flow>

Next, each of the machine learning process and the identification process described above will be described. Note that the processing order within each of the processes may be changed as appropriate as long as there is no contradiction.

(Machine Learning Process)

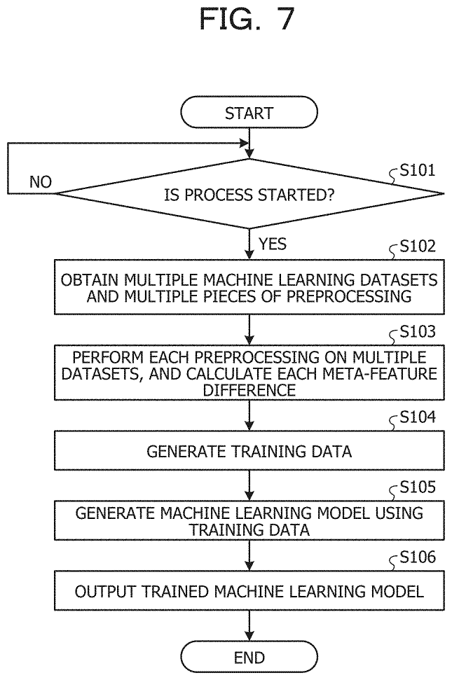

FIG. 7 is a flowchart illustrating a flow of the machine learning process according to the first embodiment. As illustrated in FIG. 7, when the machine learning unit 30 is instructed to start the process (Yes in S101), it obtains a plurality of machine learning datasets and a plurality of pieces of preprocessing (S102). For example, the machine learning unit 30 receives inputs of a plurality of datasets (dataset_D₁ to dataset_D_{N}) and a plurality of pieces of preprocessing (preprocessing_T₁ to preprocessing_T_{M}).

Subsequently, the machine learning unit 30 performs the individual pieces of preprocessing on the plurality of datasets, and calculates individual meta-feature differences (S103). For example, the machine learning unit 30 performs each of preprocessing_T₁ to preprocessing_T_{M} on each of dataset_D₁ to dataset_D_{N}. Then, the machine learning unit 30 calculates the meta-feature differences (meta-feature-difference_M_{i,j} when preprocessing_Tⱼ is performed on dataset_D₁, for example).

Thereafter, the machine learning unit 30 generates training data using a result of executing the provided preprocessing on the provided dataset (S104). For example, the machine learning unit 30 calculates meta-feature-difference_M_{i,j} for all “i,j”, and generates training data in which the meta-feature-difference_M_{i,j} is set as a feature (explanatory variable) and preprocessing_Tⱼ is set as an objective variable.

Then, the machine learning unit 30 generates the machine learning model 14 using the training data (S105). Thereafter, the machine learning unit 30 outputs the trained machine learning model 14 to the storage unit 12 or the like (S106). For example, the machine learning unit 30 executes the training of the machine learning model 14, which is a multiclass classifier, using the training data in which meta-feature-difference_M_{i,j} is set as the feature (explanatory variable) and preprocessing_Tⱼ is set as the objective variable, and outputs the trained multiclass classifier (machine learning model 14).

(Identification Process)

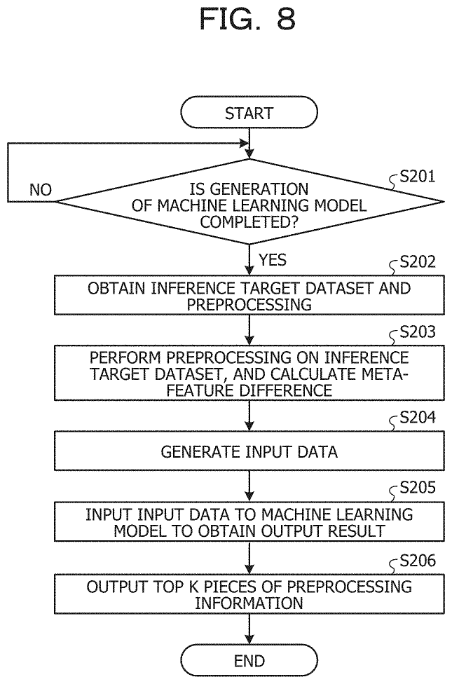

FIG. 8 is a flowchart illustrating a flow of the identification process according to the first embodiment. As illustrated in FIG. 8, when generation of the machine learning model 14 is completed (Yes in S201), the inference unit 40 obtains a provided inference target dataset and preprocessing (S202). For example, the machine learning unit 30 receives input of a dataset (dataset_D) and preprocessing (preprocessing_T).

Subsequently, the inference unit 40 performs the preprocessing on the inference target dataset, and calculates a meta-feature difference (S203). For example, the inference unit 40 calculates a meta-feature difference (meta-feature-difference_M) when preprocessing_T is performed on dataset_D.

Then, the inference unit 40 generates input data (S204), inputs the input data to the machine learning model 14 to obtain an output result (S205), and outputs top K pieces of preprocessing information (S206). For example, the inference unit 40 inputs meta-feature-difference_M to the machine learning model 14 as input data, and outputs preprocessing_t₁ to preprocessing_t_{K}, which are the top K pieces of preprocessing (preprocessing information) with a high probability of being output.

<Effects>

As described above, the information processing device 10 performs a plurality of pieces of preprocessing on a plurality of datasets, and collects sets of the “meta-feature difference of the dataset and the preprocessing information”. The information processing device 10 executes training of a multiclass classifier to infer preprocessing from the meta-feature difference of the dataset. When a new dataset and preprocessing are provided, the information processing device 10 inputs a meta-feature difference thereof to the multiclass classifier, and outputs K pieces of preprocessing information in descending order of prediction probability.

In this manner, the information processing device 10 focuses on a change of the dataset caused by the preprocessing, whereby, even in a case where no preprocessing document is available, it becomes possible to accurately identify preprocessing similar to the provided preprocessing, and to automatically determine another piece of similar preprocessing to be searched for other than the provided preprocessing.

Furthermore, the information processing device 10 uses, as a meta-feature difference, a feature difference, which is a difference between a dataset feature before performing specific preprocessing on a dataset to be subject to inference and a dataset feature after performing the specific preprocessing on the dataset, for training data. As a result, the information processing device 10 is enabled to select similar preprocessing by directly considering the preprocessing contents, and to identify the similar preprocessing highly accurately.

### Second Embodiment

While an exemplary case of using a meta-feature difference before and after preprocessing as an explanatory variable has been described in the first embodiment, it is not limited to this. Various features may be used as explanatory variables as long as they are meta-feature change amounts before and after preprocessing. In view of the above, in a second embodiment, an exemplary case of further using each meta-feature before and after preprocessing as a meta-feature change amount will be described. For example, in the second embodiment, an exemplary case of using, as explanatory variables (features), “a meta-feature before preprocessing, a meta-feature after preprocessing, and a meta-feature difference before and after preprocessing” will be described.

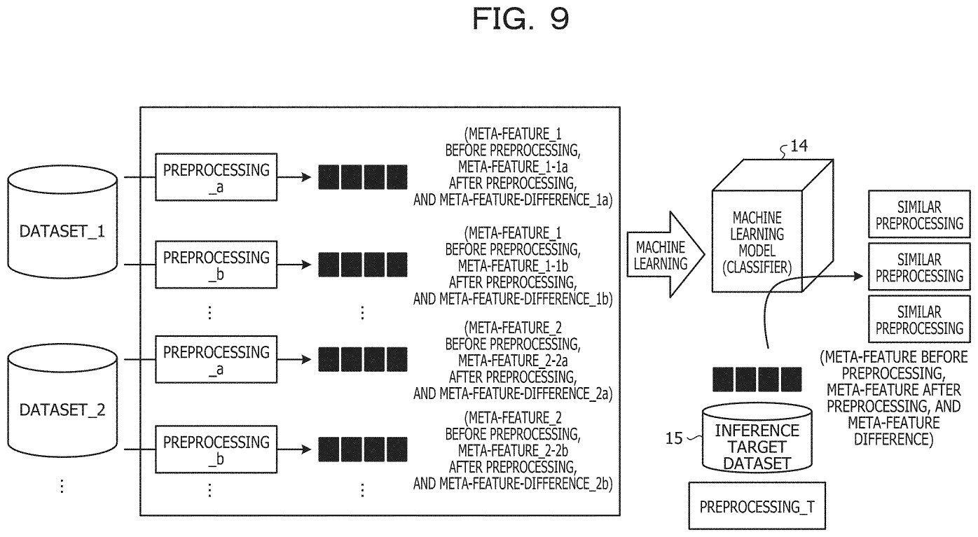

FIG. 9 is a diagram illustrating identification of similar preprocessing according to the second embodiment. As illustrated in FIG. 9, the machine learning unit 30 of the information processing device 10 generates meta-feature_1 from dataset_1. Subsequently, the machine learning unit 30 performs preprocessing_a on dataset_1, and generates meta-feature_1-1a of dataset_1 after preprocessing. Furthermore, the machine learning unit 30 calculates “(meta-feature_1)−(meta-feature_1-1a)” as meta-feature-difference_1a. Then, the preprocessing unit 31 generates “preprocessing_a information and (meta-feature_1, meta-feature_1-1a, and meta-feature-difference_1a)” as “objective variable and explanatory variable”.

Furthermore, the machine learning unit 30 performs preprocessing_b on dataset_1, and generates meta-feature_1-1b of dataset_1 after preprocessing. Furthermore, the machine learning unit 30 calculates “(meta-feature_1)−(meta-feature_1-1b)” as meta-feature-difference_1b. Then, the preprocessing unit 31 generates “preprocessing_b information and (meta-feature_1, meta-feature_1-1b, and meta-feature-difference_1b)” as “objective variable and explanatory variable”.

The machine learning unit 30 generates meta-feature_2 from dataset_2 in a similar manner. Subsequently, the machine learning unit 30 performs preprocessing_a on dataset_2, and generates meta-feature_2-2a of the dataset_2 after preprocessing. Furthermore, the machine learning unit 30 calculates “(meta-feature_2)−(meta-feature_2-2a)” as meta-feature-difference_2a. Then, the preprocessing unit 31 generates “preprocessing_a information and (meta-feature_2, meta-feature_2-2a, and meta-feature-difference_2a)” as “objective variable and explanatory variable”.

Furthermore, the machine learning unit 30 performs preprocessing_b on dataset_2, and generates meta-feature_2-2b of dataset_2 after preprocessing. Furthermore, the machine learning unit 30 calculates “(meta-feature_2)−(meta-feature_2-2b)” as meta-feature-difference_2b. Then, the preprocessing unit 31 generates “preprocessing_b information and (meta-feature_2, meta-feature_2-2b, and meta-feature-difference_2b)” as “objective variable and explanatory variable”.

In this manner, the machine learning unit 30 calculates a meta-feature difference when each piece of the provided preprocessing is executed for each of the provided datasets. Then, the machine learning unit 30 associates the “preprocessing” with the “meta-feature before preprocessing, meta-feature after preprocessing, and meta-feature difference”, thereby generating training data.

Then, the machine learning unit 30 executes training of a machine learning model 14 using the training data in which the “preprocessing” is associated with the “meta-feature before preprocessing, meta-feature after preprocessing, and meta-feature difference”.

After the machine learning is completed, an inference unit 40 generates a “meta-feature before preprocessing” of a provided inference target dataset 15. Subsequently, the inference unit 40 performs preprocessing_T on the inference target dataset 15, and generates a “meta-feature after preprocessing” of the inference target dataset 15 after the execution of preprocessing_T. Then, the inference unit 40 calculates a “meta-feature difference” by “(meta-feature before preprocessing)−(meta-feature after preprocessing)”.

Then, the inference unit 40 inputs the generated “meta-feature before preprocessing, meta-feature after preprocessing, and meta-feature difference” to the machine learning model 14, and obtains an output result. Then, the inference unit 40 identifies similar-preprocessing_1, similar-preprocessing_2, and similar-preprocessing_3 as the top K (K is any number) pieces of similar preprocessing with a high prediction probability in the output result.

In this manner, the information processing device 10 according to the second embodiment is enabled to generate the machine learning model 14 by the machine learning using, in addition to the meta-feature difference, the “meta-feature before preprocessing and meta-feature after preprocessing” as the explanatory variables. As a result, the information processing device 10 is enabled to add information reflecting the preprocessing contents, whereby accuracy in selecting another piece of similar preprocessing to be searched for may be improved.

### Third Embodiment

While an exemplary case of using, as explanatory variables (features), “a meta-feature before preprocessing, a meta-feature after preprocessing, and a meta-feature difference before and after preprocessing” has been described in the second embodiment, it is not limited to this. Meta-features before and after preprocessing may be combined optionally. In view of the above, in a third embodiment, an exemplary case of using each meta-feature before and after preprocessing instead of a meta-feature difference will be described. For example, in the third embodiment, an exemplary case of using, as explanatory variables (features), “a meta-feature before preprocessing and a meta-feature after preprocessing” will be described.

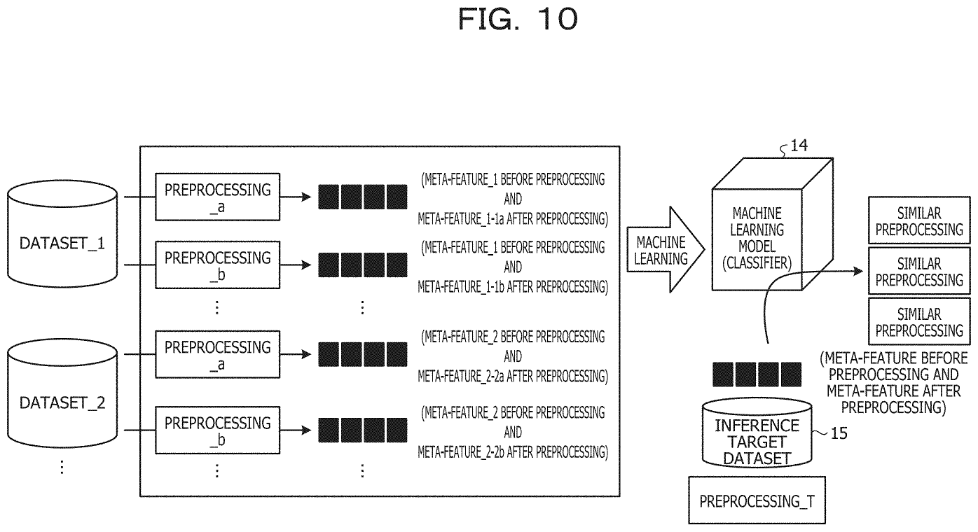

FIG. 10 is a diagram illustrating identification of similar preprocessing according to the third embodiment. As illustrated in FIG. 10, the machine learning unit 30 of the information processing device 10 generates meta-feature_1 from dataset_1. Subsequently, the machine learning unit 30 performs preprocessing_a on dataset_1, and generates meta-feature_1-1a of dataset_1 after preprocessing. Then, the preprocessing unit 31 generates “preprocessing_a information and (meta-feature_1 and meta-feature_1-1a)” as “objective variable and explanatory variable”.

Furthermore, the machine learning unit 30 performs preprocessing_b on dataset_1, and generates meta-feature_1-1b of dataset_1 after preprocessing. Then, the preprocessing unit 31 generates “preprocessing_b information and (meta-feature_1 and meta-feature_1-1b)” as “objective variable and explanatory variable”.

The machine learning unit 30 generates meta-feature_2 from dataset_2 in a similar manner. Subsequently, the machine learning unit 30 performs preprocessing_a on dataset_2, and generates meta-feature_2-2a of dataset_2 after preprocessing. Then, the preprocessing unit 31 generates “preprocessing_a information and (meta-feature_2 and meta-feature_2-2a)” as “objective variable and explanatory variable”.

Furthermore, the machine learning unit 30 performs preprocessing_b on dataset_2, and generates meta-feature_2-2b of dataset_2 after preprocessing. Then, the preprocessing unit 31 generates “preprocessing_b information and (meta-feature_2 and meta-feature_2-2b)” as “objective variable and explanatory variable”.

In this manner, the machine learning unit 30 calculates a meta-feature difference when each piece of the provided preprocessing is executed for each of the provided datasets. Then, the machine learning unit 30 associates the “preprocessing” with the “meta-feature before preprocessing and meta-feature after preprocessing”, thereby generating training data.

Then, the machine learning unit 30 executes training of the machine learning model 14 using the training data in which the “preprocessing” is associated with the “meta-feature before preprocessing and meta-feature after preprocessing”.

After the machine learning is completed, the inference unit 40 generates a “meta-feature before preprocessing” of the provided inference target dataset 15. Subsequently, the inference unit 40 performs preprocessing_T on the inference target dataset 15, and generates a “meta-feature after preprocessing” of the inference target dataset 15 after the execution of the preprocessing_T.

Then, the inference unit 40 inputs the generated “meta-feature before preprocessing and meta-feature after preprocessing” to the machine learning model 14, and obtains an output result. Then, the inference unit 40 identifies similar-preprocessing_1, similar-preprocessing_2, and similar-preprocessing_3 as the top K (K is any number) pieces of similar preprocessing with a high prediction probability in the output result.

In this manner, the information processing device 10 according to the third embodiment is enabled to generate the machine learning model 14 by the machine learning using, instead of the meta-feature difference, the “meta-feature before preprocessing and meta-feature after preprocessing” as the explanatory variables. As a result, the information processing device 10 is enabled to add information reflecting the preprocessing contents, whereby accuracy in selecting another piece of similar preprocessing to be searched for may be improved.

### Fourth Embodiment

While the embodiments have been described above, the embodiments may be implemented in a variety of different modes in addition to the embodiments described above.

[Numerical Values, Etc.]

The exemplary datasets, exemplary numerical values, exemplary data, column name, number of columns, number of data, and the like used in the embodiments described above are merely examples, and may be changed optionally. Furthermore, the flow of the process described in each flowchart may be appropriately changed as long as there is no contradiction. Note that the preprocessing provided at the time of inference is an example of the specific preprocessing.

<System>

Pieces of information including a processing procedure, a control procedure, a specific name, various types of data, and parameters described above or illustrated in the drawings may be optionally changed unless otherwise noted.

Furthermore, each component of each device illustrated in the drawings is functionally conceptual, and is not necessarily physically configured as illustrated in the drawings. For example, specific forms of distribution and integration of the individual devices are not limited to those illustrated in the drawings. For example, all or a part of the devices may be configured by being functionally or physically distributed or integrated in optional units according to various loads, use situations, or the like. For example, the machine learning unit 30 and the inference unit 40 may be implemented by separate computers (housings). For example, they may be implemented by an information processing device that implements a function similar to that of the machine learning unit 30 and an information processing device that implements a function similar to that of the inference unit 40.

Moreover, all or any part of individual processing functions performed in individual devices may be implemented by a central processing unit (CPU) and a program analyzed and executed by the CPU, or may be implemented as hardware by wired logic.

<Hardware>

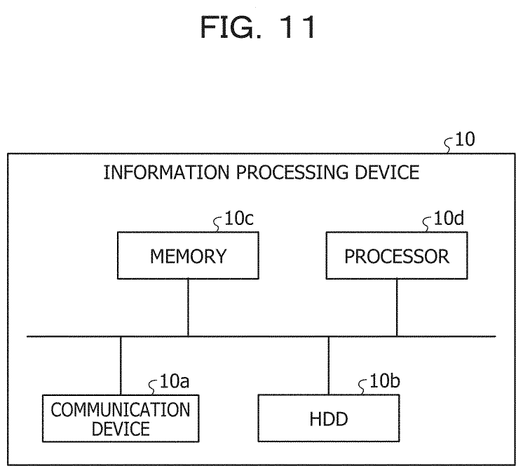

FIG. 11 is a diagram illustrating an exemplary hardware configuration. As illustrated in FIG. 11, the information processing device 10 includes a communication device 10a, a hard disk drive (HDD) 10b, a memory 10c, and a processor 10d. Furthermore, the individual units illustrated in FIG. 11 are mutually coupled by a bus or the like.

The communication device 10a is a network interface card or the like, and communicates with another device. The HDD 10b stores programs and databases (DBs) for operating the functions illustrated in FIG. 3.

The processor 10d reads, from the HDD 10b or the like, a program that executes processing similar to that of each processing unit illustrated in FIG. 3, and loads it in the memory 10c, thereby operating a process for implementing each function described with reference to FIG. 3 or the like. For example, this process implements a function similar to that of each processing unit included in the information processing device 10. For example, the processor 10d reads, from the HDD 10b or the like, a program having a function similar to that of the machine learning unit 30, the inference unit 40, or the like. Then, the processor 10d carries out a process that executes processing similar to that of the machine learning unit 30, the inference unit 40, or the like.

In this manner, the information processing device 10 reads and executes a program, thereby operating as an information processing device that executes an information processing method. Furthermore, the information processing device 10 may implement functions similar to those in the embodiments described above by reading the program described above from a recording medium with a medium reading device and executing the read program described above. Note that other programs referred to in the embodiments are not limited to being executed by the information processing device 10. For example, the embodiments described above may be also similarly applied to a case where another computer or server executes the program or a case where these cooperatively execute the program.

This program may be distributed via a network such as the Internet. Furthermore, this program may be recorded in a computer-readable recording medium such as a hard disk, a flexible disk (FD), a compact disc read only memory (CD-ROM), a magneto-optical disk (MO), a digital versatile disc (DVD), or the like, and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
obtaining first change information, which indicates a change in a feature of a first dataset when first preprocessing is performed on the first dataset;
inputting the first change information to a trained machine learning model that outputs an inference result regarding preprocessing information in response to an input of the first change information, the preprocessing information identifying each of a plurality of pieces of second preprocessing for a second dataset, the trained machine learning model being trained by machine learning using training data in which the preprocessing information as an objective variable is associated with second change information as an explanatory variable, the second change information indicating a change in a feature of the second dataset when each of the plurality of pieces of second preprocessing is performed; and
identifying, among the plurality of pieces of second preprocessing, one or more pieces of recommended preprocessing that correspond to the first preprocessing based on the inference result that is output in response to the input of the first change information.

2. The non-transitory computer-readable recording medium according to claim 1, the process further comprising:
outputting, as the one or more pieces of recommended preprocessing, a predetermined number of pieces of recommended preprocessing with a higher prediction probability among the plurality of pieces of second preprocessing.

3. The non-transitory computer-readable recording medium according to claim 1, wherein
the first change information includes a difference between the feature of the first dataset before the first preprocessing is performed and the feature of the first dataset after the first preprocessing is performed, and
the second change information includes a difference between the feature of the second dataset before each of the plurality of pieces of second preprocessing is performed and the feature of the second dataset after each of the plurality of pieces of second preprocessing is performed.

4. The non-transitory computer-readable recording medium according to claim 1, wherein
the first change information includes a first before-preprocessing feature that is the feature of the first dataset before the first preprocessing is performed, a first after-preprocessing feature that is the feature of the first dataset after the first preprocessing is performed, and a difference between the first before-preprocessing feature and the first after-preprocessing feature, and
the second change information includes a second before-preprocessing feature that is the feature of the second dataset before each of the plurality of pieces of second preprocessing is performed, a second after-preprocessing feature that is the feature of the second dataset after each of the plurality of pieces of second preprocessing is performed, and a difference between the second before-preprocessing feature and the second after-preprocessing feature.

5. The non-transitory computer-readable recording medium according to claim 1, wherein
the first change information includes the feature of the first dataset before the first preprocessing is performed and the feature of the first dataset after the first preprocessing is performed, and
the second change information includes the feature of the second dataset before each of the plurality of pieces of second preprocessing is performed and the feature of the second dataset after each of the plurality of pieces of second preprocessing is performed.

6. The non-transitory computer-readable recording medium according to claim 1, wherein
the feature of the first dataset is generated using at least one of data that includes a number of rows of the first dataset and a number of columns of the first dataset excluding an objective variable, a number of columns of numerical data included in the first dataset, a number of columns of character strings included in the first dataset, a percentage of data missing values included in the first dataset, a statistic of each column included in the first dataset, or a number of classes of the objective variable included in the first dataset.

7. An identification method, comprising:
obtaining, by a computer, first change information, which indicates a change in a feature of a first dataset when first preprocessing is performed on the first dataset;
inputting the first change information to a trained machine learning model that outputs an inference result regarding preprocessing information in response to an input of the first change information, the preprocessing information identifying each of a plurality of pieces of second preprocessing for a second dataset, the trained machine learning model being trained by machine learning using training data in which the preprocessing information as an objective variable is associated with second change information as an explanatory variable, the second change information indicating a change in a feature of the second dataset when each of the plurality of pieces of second preprocessing is performed; and
identifying, among the plurality of pieces of second preprocessing, one or more pieces of recommended preprocessing that correspond to the first preprocessing based on the inference result that is output in response to the input of the first change information.

8. An information processing device, comprising:
a memory; and
a processor coupled to the memory and the processor configured to:
obtain first change information, which indicates a change in a feature of a first dataset when first preprocessing is performed on the first dataset;
input the first change information to a trained machine learning model that outputs an inference result regarding preprocessing information in response to an input of the first change information, the preprocessing information identifying each of a plurality of pieces of second preprocessing for a second dataset, the trained machine learning model being trained by machine learning using training data in which the preprocessing information as an objective variable is associated with second change information as an explanatory variable, the second change information indicating a change in a feature of the second dataset when each of the plurality of pieces of second preprocessing is performed; and
identify, among the plurality of pieces of second preprocessing, one or more pieces of recommended preprocessing that correspond to the first preprocessing based on the inference result that is output in response to the input of the first change information.
